(19) United States
(12) Patent Application Publication
(10) Pub. No.: US 2005/0037709 A1
(43) Pub. Date: Feb. 17, 2005

(54) Apparatus and method for printing from data provided by a mobile communications device

(76) Inventor: Pete Hwang, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/641,630

(22) Filed: Aug. 14, 2003

(51) Int. Cl. H04B 1/00

(52) U.S. Cl. 455/66.1; 455/41.2

(57) ABSTRACT

A printing apparatus includes a printer with a detachable faceplate configured to receive data from a mobile communications device.

### BACKGROUND OF THE INVENTION

Cellular telephones (hereinafter “cellphones”) and other mobile communications devices are beginning to frequently include image capture devices. For example, many manufacturers are presently equipping their mobile telephones and similar products with on-board digital cameras, displays, and data storage devices.

Typically, data for images captured by camera phones are stored on small-sized memory cards, sticks or other devices that can be physically removed from the camera phone and plugged into a memory device reader, slot, etc. on a personal computer (PC) or printer. The image data are then read from the memory device and used to generate printouts of the stored digital images.

However, difficulties can arise for people who are not able (due to a lack of dexterity, poor vision, etc.) to remove a postage stamp sized memory card from their camera phone and plug it into a card reader at their PC or printer. Opportunities abound for memory cards to be dropped, damaged or lost. Other camera phones are configured to allow users to download images onto their PCs where they can be opened with an image editor and printed at a printer controlled by the PC.

Neither of these approaches to printing hardcopies of digital images is particularly convenient or conducive to spontaneous printing of photos by novice or casual users. Moreover, some camera phone users perceive any activity involving a PC to be threatening, difficult or tedious, or as something that resembles work and, therefore, may elect not to print their stored images in the face of such obstacles.

Accordingly, it would be desirable to be able to provide a convenient, easily accessible, “low effort” path for camera phone users to generate prints of their stored images. It would also be desirable to be able to provide a digital image printer that is small in size. Moreover, it would be desirable to be able to provide a printing solution that permits camera phone users to print images more frequently due to one or more of its convenience, accessibility and integrated functionality.

### BRIEF DESCRIPTION OF THE DRAWINGS

Detailed description of embodiments of the invention will be made with reference to the accompanying drawings:

FIG. 1 is a perspective view of a photo printer and a mobile communications device according to an embodiment of the present invention;

FIG. 2 shows the photo printer of FIG. 1 with a plurality of different detachable faceplates;

FIG. 3 is a partial cross-sectional side view of the photo printer of FIG. 1 with the mobile communications device positioned in the faceplate cradle;

FIG. 4 is a functional block diagram of a photo printer and a mobile communications device according to an embodiment of the present invention; and

FIG. 5 is a perspective view of a photo printer and a mobile communications device according to another embodiment of the present invention.

### DETAILED DESCRIPTION

The following is a detailed description for carrying out the invention. This description is not to be taken in a limiting sense, but is made merely for the purpose of illustrating the general principles of the invention.

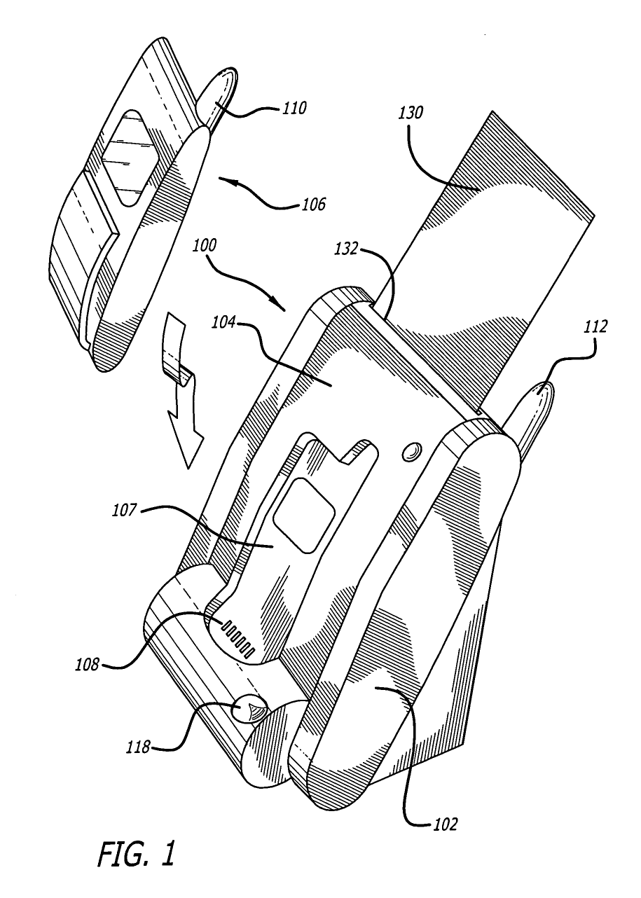

The example embodiments of the present invention relate to apparatuses and methods for printing from data provided by a mobile communications device (MCD). As used herein, the term “photo printer” means a printer that is capable of printing on photo paper and possibly also on other types of media such as plain paper, multi-purpose paper, etc. Referring to FIG. 1, an example embodiment of a photo printer 100 according to the present invention includes a housing 102 with a detachable faceplate 104 that is configured to receive image data and/or other types of data from a mobile communications device 106. The housing 102 and the detachable faceplate 104 can be formed from various plastics, such as high impact polystyrene, acrylonitrile-butadiene-styrene (ABS), or polycarbonate, cast or stamped metal, as well as other materials.

In the illustrated example embodiment, the detachable faceplate 104 includes a cradle with a recessed portion 107 sized to accommodate a back portion of the mobile communications device 106, and the photo printer 100 is configured to receive the data when the mobile communications device 106 is held in the cradle. As shown, the recessed portion 107 can take the form of an imprint of the mobile communications device 106 embossed onto the cradle. In the illustrated example embodiment, the data can be received via an electronic interface 108 positioned in the detachable faceplate 104 (e.g., at the bottom of the cradle as shown) or via a mechanism for establishing a wireless communications link with the mobile communications device 106.

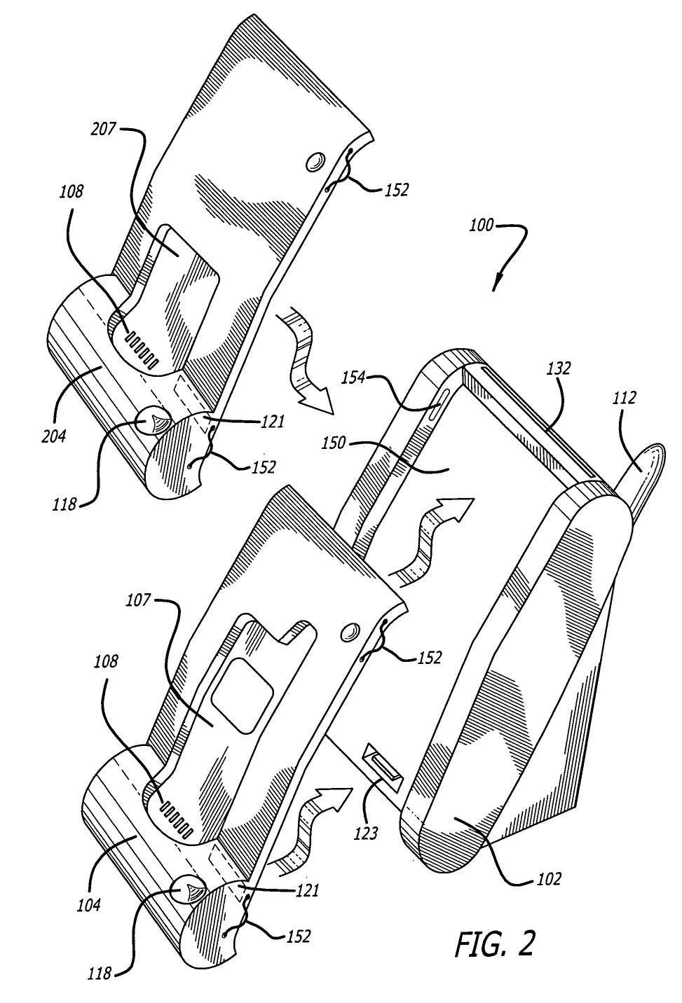

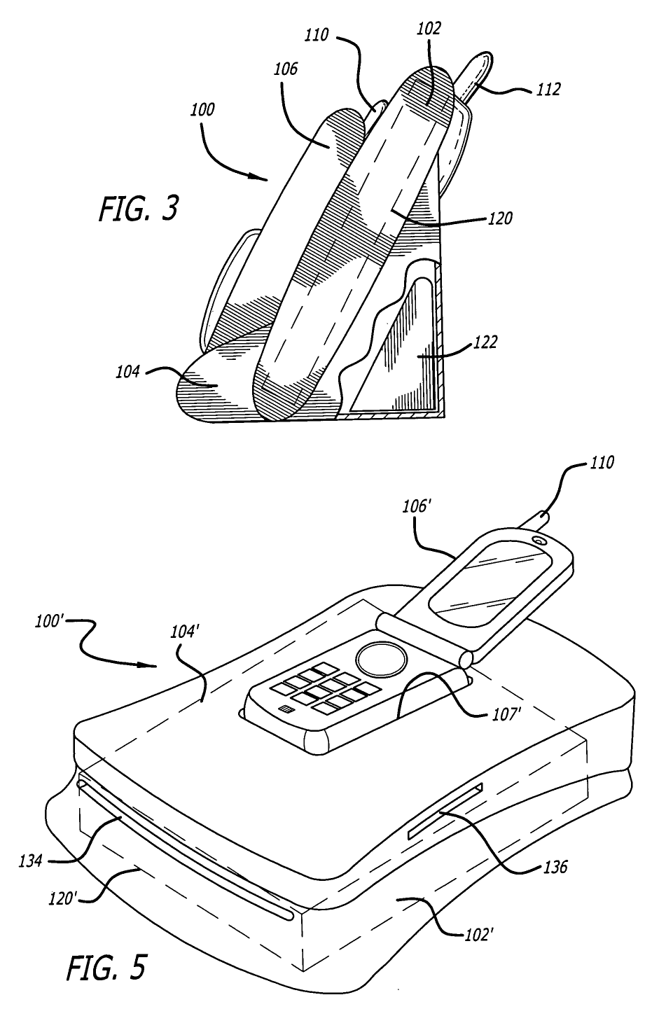

Referring to FIG. 2, the detachable faceplate 104 is sized to fit within a recessed portion 150 of the housing 102. The illustrated example faceplate 104 is formed with protruding portions 152 that are sized to mechanically interfit (e.g., snap fit) with complementary recessed portions 154 of the housing 102. It should be appreciated that the protruding portions 152 and recessed portions 154 can be formed in any complementary fashion on either the housing 102 or the detachable faceplate 104, as well as at locations other than those shown in this illustrated example. Moreover, other mechanisms for detachably securing the faceplate 104 to the housing 102 can be employed (such as clips, screws, etc.)

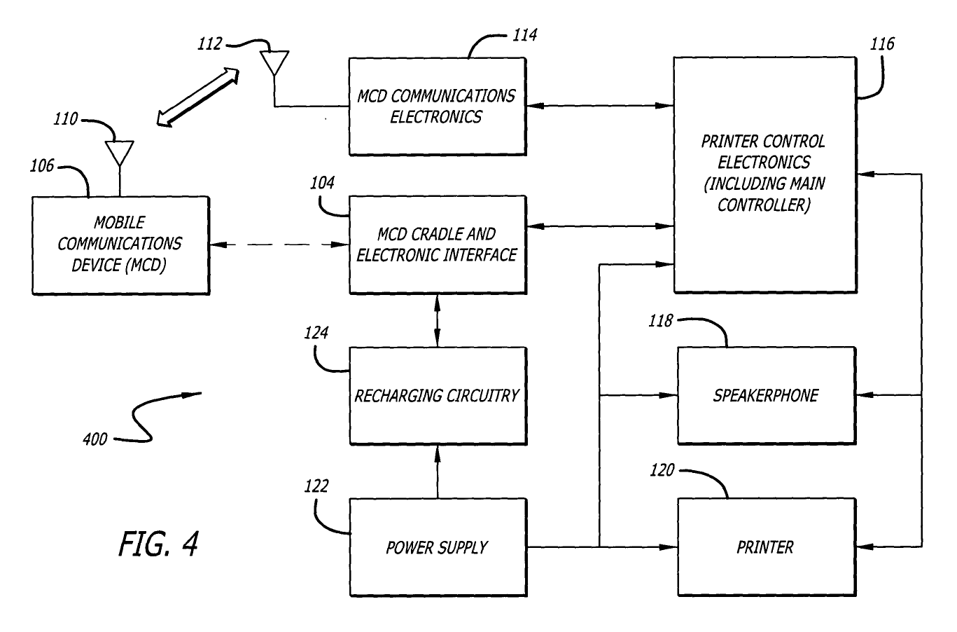

Referring to FIG. 4, the mechanism for establishing a wireless communications link (e.g., between an antenna 110 of the mobile communications device 106 and an antenna 112 of the photo printer 100) includes communications electronics 114 (e.g. cellphone electronics) that are located in the housing 102 or the detachable faceplate 104. In this example embodiment, the photo printer 100 also includes printer control electronics (including a main controller) 116, a speakerphone 118 (including a speaker and a microphone), a printer 120, a power supply 122 and recharging circuitry 124 functionally interconnected as shown. The communications electronics 114 can be separate from or part of the printer control electronics 116 and allow the cradle to function as its own communications station implementing, by way of example, Bluetooth, 802.11 or third generation (3G) communications technologies. In operation, the communications electronics 114 allow a user to print photos, images, text, etc. by providing user inputs at the mobile communications device 106 (e.g., while lying on the beach or riding home on the train) without the mobile communications device 106 being docked to the cradle. Thus, the photo printer 100 is capable of functioning as a dedicated mini-printer for the mobile communications device 106, allowing users to print photos as well as non-photo images and text (e.g., movie schedules, bus schedules, roadmaps, tickets obtained on-line via the mobile communications device 106). This functionality is particularly helpful when a user desires a physical copy of an image displayed by the mobile communications device 106 or when the size of the image displayed by the mobile communications device 106 is too small to be able to view. Electronics for rendering image data (e.g., .jpeg data) from the mobile communications device 106 can be integrated into either the communications electronics 114 or the printer control electronics 116. As with the communications electronics 114, the printer control electronics 116, the speakerphone 118 and the recharging circuitry 124 can be located in the housing 102 and/or in the detachable faceplate 104. Interface connectors 121 and 123 (the former shown in dashed lines) disposed at the rear side of the detachable faceplate 104 and at the front side of the housing 102, respectively, are positioned such that they mate when the detachable faceplate 104 is attached to the housing 102 to provide a connection between the electronic interface 108 and the components within the housing 102.

In the illustrated example embodiment, speakerphone functionality is built into the printer control electronics 116 such that the photo printer 100 is configured to provide an operative interface between the speakerphone 118 and the mobile communications device 106 when the mobile communications device 106 is held in the cradle. For example, the speakerphone 118 becomes active when the mobile communications device 106 is loaded into the cradle thereby facilitating hands free operation. More specifically, in this example, the speaker and microphone of the speakerphone 118 are operatively coupled to the mobile communications device 106 when the mobile communications device 106 is loaded into the cradle. Thus, according to an embodiment of the present invention, an accessory for a mobile communications device includes a printer with a speakerphone, the printer being configured to receive data from a mobile communications device and to provide an operative interface between the speakerphone and the mobile communications device. According to another embodiment, a method of providing a printer for a mobile communications device includes the steps of: identifying a printer; and providing the printer with a detachable cradle configured to hold a mobile communications device and to operatively interface between the printer and the mobile communications device.

In the illustrated example embodiment, the photo printer 100 also includes a mechanism for recharging the mobile communications device 106 when the mobile communications device 106 is held in the cradle, namely, the recharging circuitry 124 and the electronic interface 108 (which provides electrical connections for both recharging the mobile communications device 106 and transmitting data to the printer control electronics 116). Thus, according to an embodiment of the present invention, an accessory for a mobile communications device includes a cradle sized to receive and support a mobile communications device, the cradle including a recharger mechanism, a printer, and a faceplate adapted to provide recharging and data transfer interfaces to the recharger mechanism and the printer, respectively.

In this illustrated example embodiment of the photo printer 100, the cradle and the detachable faceplate 104 are tilted backward relative to the front side of the photo printer 100. This tilted configuration provides a support structure (backrest) to hold the mobile communications device 106 for “dropping in” and “retrieving” the mobile communications device 106 from the cradle.

The printer 120 inside the housing 102—by way of example, a color printer configured for printing on photo-sized media (e.g., 4×6 or L-size)—is also tilted backward relative to the front side of the photo printer 100. Thus, according to an embodiment of the present invention, an accessory for a mobile communications device includes a printer configured to receive data from a mobile communications device, the printer including a printing mechanism that is tilted (e.g., backward at an angle of 10-15 degrees from upright) such that an upper portion of the printing mechanism is further away from a front portion of the printer than a lower portion of the printing mechanism.

In this illustrated example embodiment, the printing mechanism is housed vertically with its output zone on top. Referring to FIG. 1, the printing mechanism is configured to advance a printed photograph 130 such that the printed photograph 130 emerges from a slot 132 at the upper portion of the printing mechanism and is held in a presentation position generally facing the front portion of the photo printer 100. In this illustrated example embodiment, the presentation position is tilted backward (e.g., at an angle of 15-10 degrees) relative to the front portion of the photo printer 100. Thus, according to an embodiment of the present invention, a method of printing includes the steps of: providing data from a mobile communications device to a printer; employing the printer and the data to print an article of media; and advancing the article of media to a printed media presentation position above the printer such that the article of media emerges from the printer at an angle tilted backward with respect to a front side of the printer. In another embodiment, the step of providing data includes establishing an electrical interconnection between the mobile communications device and the printer (for example, by docking the mobile communications device together with the printer). In another embodiment, the step of providing data includes transmitting the data via a wireless communications link.

In addition to saving (desktop) space via a smaller photo printer footprint and providing the afore-described printed media presentation position, the tilted printing mechanism configuration allows the power supply 122 to be integrated into a rear portion of the photo printer 100 behind the printing mechanism. In this illustrated example embodiment, the power supply 122 is complementary in shape to the printing mechanism. In this illustrated example embodiment, the power supply 122 is generally triangular in shape, or wedge-shaped, viewing the photo printer 100 in profile. Thus, according to an embodiment of the present invention, an accessory for a mobile communications device includes a printer configured to receive data from a mobile communications device, the printer including a printing mechanism and a power supply, the power supply being integrated into a rear portion of the printer and complementary in shape to the printing mechanism.

According to another example embodiment of the present invention, the photo printer 100 is configured to be operatively interconnectable with a plurality of different detachable faceplates. For example, each of the different detachable faceplates is configured to receive and operatively interface with a different mobile communications device. Referring to FIG. 2, an example of a different detachable faceplate 204 is shown. The detachable faceplate 204 is the same as the detachable faceplate 104 except that it is configured with a recessed portion 207 sized to accommodate a mobile communications device of a different size that that which is accommodated in the recessed portion 107 of the detachable faceplate 104. Although both of the detachable faceplates 104 and 204 are shown as having the same electronic interface 108, different electronic interfaces can be provided to accommodate different mobile communications devices.

By providing the photo printer 100 with “custom” detachable faceplates for different mobile communications devices, the photo printer 100 becomes an even more versatile accessory. It is also contemplated that the mobile communications device accessory may simply be the faceplate, rather than the entire photo printer, allowing a single photo printer to accommodate a plurality of mobile communications devices with different shapes and/or signal interfaces. Thus, according to an embodiment of the present invention, a printing apparatus includes a printer configured to be operatively interconnectable with a plurality of different cradle mechanisms that are respectively configured to receive data from a plurality of different mobile communications devices. Individual cradle mechanisms are configured to receive a mobile communications device of a particular shape, size, and electrical interface. As discussed above, the cradle mechanisms can be configured to receive the data via a wireless communications link.

According to another embodiment of the present invention, a method of providing a printer for a mobile communications device includes: identifying a printer; and selecting, from a plurality of different modular interface mechanisms, an interface mechanism configured to detachably engage with the printer and to provide an operative interface between the printer and a mobile communications device depending upon shape and electrical interface characteristics of the mobile communications device. Alternatively, components of a printer/mobile communications device combination that support such an operative interface can be provided together (e.g., packaged together for retail sale) to eliminate the possibility that a consumer will attempt to pair a mobile communications device with an incompatible printer. Referring to FIG. 5, in another example embodiment of the present invention, a photo printer 100′ includes a housing 102′ with a detachable faceplate 104′ that is configured to receive image data and/or other types of data from a mobile communications device 106′. The housing 102′ includes a printer 120′ that is configured to be substantially horizontal relative to the bottom side of the housing 102′. In this illustrated example embodiment, the housing 102′ and the printer 120′ are configured such that printed media emerge from a slot 134 at the front portion of the photo printer 100′. In this illustrated example embodiment, the housing 102′ does not include an integrated power supply, but rather employs an external power supply. It should be appreciated, however, that the shape of the housing 102′ can be modified so that the housing 102 has sufficient space to include a power supply.

In this illustrated example embodiment, the detachable faceplate 104′ includes a cradle/recessed portion 107′ which is horizontally positioned relative to a bottom side of the photo printer 100′. In this illustrated example embodiment, the detachable faceplate 104′ includes a slot 136 through which a memory device (e.g., memory card, stick or the like) from a mobile communications device can be inserted into the detachable faceplate 104′ and interfaced with the memory device reader. After establishing a wireless communications link as discussed above, the mobile communications device 106′, with its built-in photo (or other image) preview screen, can be used as a remote control to view digital images stored on the memory device inserted into the slot 136. Remote control functions can also include adjusting the color/contrast, cropping at the preview screen, selecting how many copies are to be printed, etc. This embodiment allows a user, in a leisurely fashion, to sort through digital images stored on a plurality of memory devices, e.g., after a long holiday during which many images were captured and stored on different memory devices. It should be understood that the photo printer 100 (FIG. 1) can also be configured with slots in this manner to provide an alternate memory device interface mechanism. The other components of the photo printer 100′ are the same as those of the photo printer 100.

Various embodiments of the present invention thus serve as a “base station” for a mobile communications device, i.e., a place where a mobile communications device can be docked when it is not being actively used. Various embodiments of the present invention also serve as an “all-in-one” base station providing a combination of features such as a built-in printer, recharger, power supply, and speakerphone.

The present invention, according to some embodiments, also facilitates the creation of revenue streams (e.g., for wireless communications network service providers) based on usage of the photo printer 100. It is further contemplated that the recipients of such revenue streams may also arrange to have the photo printers provided to mobile communications device users for free or at a subsidized cost, perhaps for the purpose of increasing market penetration for their wireless communications services. Thus, according to an embodiment of the present invention, a method of providing a printer for a mobile communications device includes the steps of: providing a printer that is configured such that a mobile communications device can establish a wireless communications link with the printer; enabling a user of the mobile communications device to establish the wireless communications link and to transmit data from the mobile communications device to the printer via the wireless communications link; monitoring transfers of data from the mobile communications device to the printer; and debiting an account associated with the user depending upon usage of the printer involving the transfers of data. In another embodiment, the method further includes the step of using a Bluetooth, 802.11 or third generation (3G) wireless system to provide the wireless communications link.

Although the present invention has been described in terms of the example embodiments above, numerous modifications and/or additions to the above-described embodiments would be readily apparent to one skilled in the art. It is intended that the scope of the present invention extends to all such modifications and/or additions.

1. A printing apparatus, comprising:
a printer with a detachable faceplate configured to receive data from a mobile communications device.

2. The printing apparatus of claim 1, wherein the printer is a photo printer.

3. The printing apparatus of claim 1, wherein the detachable faceplate includes a cradle, and the printer is configured to receive the data when the mobile communications device is held in the cradle.

4. The printing apparatus of claim 3, wherein the cradle includes a recessed portion sized to accommodate a back portion of the mobile communications device.

5. The printing apparatus of claim 1, wherein the printer includes means for establishing a wireless communications link with the mobile communications device.

6. The printing apparatus of claim 1, wherein the detachable faceplate includes means for establishing a wireless communications link with the mobile communications device.

7. The printing apparatus of claim 3, further comprising:
a speakerphone, the printer being configured to provide an operative interface between the speakerphone and the mobile communications device when the mobile communications device is held in the cradle.

8. The printing apparatus of claim 3, further comprising:
means for recharging the mobile communications device when the mobile communications device is held in the cradle.

9. The printing apparatus of claim 1, wherein the printer includes a printing mechanism that is tilted backward relative to a front side of the printer.

10. The printing apparatus of claim 9, wherein the printer includes a power supply that is positioned behind the printing mechanism and integrated within a housing of the printer.

11. The printing apparatus of claim 1, wherein the printer includes a printing mechanism that is horizontally positioned relative to a bottom side of the printer.

12. The printing apparatus of claim 3, wherein the cradle is tilted backward relative to a front side of the printer.

13. The printing apparatus of claim 3, wherein the cradle is horizontally positioned relative to a bottom side of the printer.

14. A printing apparatus, comprising:
a printer configured to be operatively interconnectable with a plurality of different cradle mechanisms that are respectively configured to receive data from a plurality of differently configured mobile communications devices.

15. The printing apparatus of claim 14, wherein the printer is a photo printer.

16. The printing apparatus of claim 14, wherein one or more of the cradle mechanisms is configured to receive the data via a wireless communications link.

17. The printing apparatus of claim 14, further comprising:
a speakerphone including a speaker and a microphone;
wherein the printer is configured to provide an operative interface between a mobile communications device and the speakerphone when one of the cradle mechanisms is operatively interconnected with the printer and the mobile communications device is held in the cradle mechanism.

18. The printing apparatus of claim 14, further comprising:
means for recharging a mobile communications device when one of the cradle mechanisms is operatively interconnected with the printer and the mobile communications device is held in the cradle mechanism.

19. The printing apparatus of claim 14, wherein the printer includes a printing mechanism that is tilted backward relative to a front side of the printer.

20. The printing apparatus of claim 19, wherein the printer includes a power supply that is positioned behind the printing mechanism and integrated within a housing of the printer.

21. The printing apparatus of claim 14, wherein the printer includes a printing mechanism that is horizontally positioned relative to a bottom side of the printer.

22. The printing apparatus of claim 14, wherein one of the cradle mechanisms is tilted backward relative to a front side of the printer when the printer is operatively interconnected with the cradle mechanism.

23. The printing apparatus of claim 14, wherein one of the cradle mechanisms is horizontally positioned relative to a bottom side of the printer when the printer is operatively interconnected with the cradle mechanism.

24. An accessory for a mobile communications device, comprising:
a cradle sized to receive and support a mobile communications device, the cradle including a recharger mechanism, a printer, and a faceplate adapted to provide recharging and data transfer interfaces to the recharger mechanism and the printer, respectively.

25. The accessory for a mobile communications device of claim 24, wherein the printer is a photo printer.

26. The accessory for a mobile communications device of claim 24, wherein the cradle is configured to receive the data when the mobile communications device is held in the cradle.

27. The accessory for a mobile communications device of claim 26, wherein the cradle includes a recessed portion sized to accommodate a back portion of the mobile communications device.

28. The accessory for a mobile communications device of claim 24, wherein the cradle includes means for establishing a wireless communications link with the mobile communications device.

29. The accessory for a mobile communications device of claim 24, further comprising:
a speakerphone including a speaker and a microphone, the cradle being configured to provide an operative interface between the speakerphone and the mobile communications device when the mobile communications device is held in the cradle.

30. The accessory for a mobile communications device of claim 24, wherein the recharger mechanism is configured to recharge the mobile communications device when the mobile communications device is held in the cradle.

31. The accessory for a mobile communications device of claim 24, wherein the printer includes a printing mechanism that is tilted backward relative to a front side of the cradle.

32. The accessory for a mobile communications device of claim 31, further comprising:
a power supply that is positioned behind the printing mechanism.

33. The accessory for a mobile communications device of claim 24, wherein the printer includes a printing mechanism that is horizontally positioned relative to a bottom side of the cradle.

34. An accessory for a mobile communications device, comprising:
a printer configured to receive data from a mobile communications device, the printer including a printing mechanism that is tilted such that an upper portion of the printing mechanism is further away from a front portion of the printer than a lower portion of the printing mechanism.

35. The accessory for a mobile communications device of claim 34, wherein the printer is a photo printer.

36. The accessory for a mobile communications device of claim 34, wherein the printing mechanism is tilted backward at an angle of 15-20 degrees from upright.

37. The accessory for a mobile communications device of claim 34, wherein the printing mechanism is configured to advance a printed photograph such that the printed photograph emerges from the upper portion of the printing mechanism and held in a presentation position generally facing the front portion of the printer.

38. The accessory for a mobile communications device of claim 37, wherein the presentation position is tilted backward relative to the front portion of the printer.

39. The accessory for a mobile communications device of claim 34, wherein the presentation position is tilted backward at an angle of 15-20 degrees from upright.

40. The accessory for a mobile communications device of claim 34, wherein the printer includes an integrated power supply positioned behind the printing mechanism.

41. The accessory for a mobile communications device of claim 40, wherein the integrated power supply is generally triangular in shape.

42. The accessory for a mobile communications device of claim 34, wherein the printer includes means for establishing a wireless communications link with the mobile communications device.

43. The accessory for a mobile communications device of claim 34, wherein the printer includes a cradle and is configured to receive the data when the mobile communications device is held in the cradle.

44. The accessory for a mobile communications device of claim 43, wherein the cradle is tilted backward relative to the front portion of the printer.

45. The accessory for a mobile communications device of claim 43, wherein the cradle includes a recessed portion sized to accommodate a back portion of the mobile communications device.

46. The accessory for a mobile communications device of claim 43, further comprising:
a speakerphone including a speaker and a microphone, the printer being configured to provide an operative interface between the speakerphone and the mobile communications device when the mobile communications device is held in the cradle.

47. The accessory for a mobile communications device of claim 43, further comprising:
means for recharging the mobile communications device when the mobile communications device is held in the cradle.

48. An accessory for a mobile communications device, comprising:
a printer configured to receive data from a mobile communications device, the printer including a printing mechanism and a power supply, the power supply being integrated into a rear portion of the printer and complementary in shape to the printing mechanism.

49. The accessory for a mobile communications device of claim 48, wherein the printer is a photo printer.

50. The accessory for a mobile communications device of claim 48, wherein the printing mechanism is tilted backward relative to a front portion of the printer.

51. The accessory for a mobile communications device of claim 50, wherein the power supply is positioned behind the printing mechanism.

52. The accessory for a mobile communications device of claim 48, wherein the power supply is generally triangular in shape.

53. The accessory for a mobile communications device of claim 48, wherein the power supply is wedge-shaped.

54. The accessory for a mobile communications device of claim 48, wherein the printer includes means for establishing a wireless communications link with the mobile communications device.

55. The accessory for a mobile communications device of claim 48, wherein the printer includes a cradle and is configured to receive the data when the mobile communications device is held in the cradle.

56. The accessory for a mobile communications device of claim 55, wherein the cradle is tilted backward relative to a front portion of the printer.

57. The accessory for a mobile communications device of claim 55, wherein the cradle includes a recessed portion sized to accommodate a back portion of the mobile communications device.

58. The accessory for a mobile communications device of claim 55, further comprising:
a speakerphone including a speaker and a microphone;
wherein the printer is configured to provide an operative interface between the speakerphone and the mobile communications device when the mobile communications device is held in the cradle.

59. The accessory for a mobile communications device of claim 55, further comprising:
means for recharging the mobile communications device when the mobile communications device is held in the cradle.

60. An accessory for a mobile communications device, comprising:
a printer including a speakerphone with a speaker and a microphone, the printer being configured to receive data from a mobile communications device and to provide an operative interface between the speakerphone and the mobile communications device.

61. The accessory for a mobile communications device of claim 60, wherein the printer is a photo printer.

62. The accessory for a mobile communications device of claim 60, wherein the printer includes a cradle and is configured to receive the data when the mobile communications device is held in the cradle.

63. The accessory for a mobile communications device of claim 62, wherein the printer is configured to provide the operative interface between the speakerphone and the mobile communications device when the mobile communications device is held in the cradle.

64. The accessory for a mobile communications device of claim 62, wherein the cradle is tilted backward relative to a front portion of the printer.

65. The accessory for a mobile communications device of claim 62, wherein the cradle is horizontally positioned relative to a bottom side of the printer.

66. The accessory for a mobile communications device of claim 62, wherein the cradle includes a recessed portion sized to accommodate a back portion of the mobile communications device.

67. The accessory for a mobile communications device of claim 62, further comprising:
means for recharging the mobile communications device when the mobile communications device is held in the cradle.

68. The accessory for a mobile communications device of claim 60, wherein the printer includes a printing mechanism that is tilted backward relative to a front portion of the printer.

69. The accessory for a mobile communications device of claim 68, wherein the printer includes a power supply positioned behind the printing mechanism.

70. The accessory for a mobile communications device of claim 60, wherein the printer includes a printing mechanism that is horizontally positioned relative to a bottom side of the printer.

71. The accessory for a mobile communications device of claim 60, wherein the printer includes means for establishing a wireless communications link with the mobile communications device.

72. A method of printing, comprising the steps of:
providing data from a mobile communications device to a printer;
employing the printer and the data to print an article of media; and
advancing the article of media to a printed media presentation position above the printer such that the article of media emerges from the printer at an angle tilted backward with respect to a front side of the printer.

73. The method of printing of claim 72, wherein the step of providing data includes establishing an electrical interconnection between the mobile communications device and the printer.

74. The method of printing of claim 73, wherein the step of establishing an electrical interconnection includes docking the mobile communications device together with the printer.

75. The method of printing of claim 72, wherein the step of providing data includes transmitting the data via a wireless communications link.

76. A method of providing a printer for a mobile communications device, comprising the steps of:
identifying a printer; and
from a plurality of different modular interface mechanisms, selecting an interface mechanism configured to detachably engage with the printer and to provide an operative interface between the printer and a mobile communications device depending upon shape and electrical interface characteristics of the mobile communications device.

77. A method of providing a printer for a mobile communications device, comprising the steps of:
providing a printer that is configured such that a mobile communications device can establish a wireless communications link with the printer;
enabling a user of the mobile communications device to establish the wireless communications link and to transmit data from the mobile communications device to the printer via the wireless communications link;
monitoring transfers of data from the mobile communications device to the printer; and
debiting an account associated with the user depending upon usage of the printer involving the transfers of data.

78. The method of providing a printer for a mobile communications device of claim 77, wherein the printer is provided to the user at no cost.

79. The method of providing a printer for a mobile communications device of claim 77, wherein the printer is provided to the user at a subsidized cost.

80. The method of providing a printer for a mobile communications device of claim 77, further comprising the step of:
using a Bluetooth wireless system to provide the wireless communications link.

81. The method of providing a printer for a mobile communications device of claim 77, further comprising the step of:
using a 802.11 wireless system to provide the wireless communications link.

82. The method of providing a printer for a mobile communications device of claim 77, further comprising the step of:
using a third generation (3G) wireless system to provide the wireless communications link.
